(19) United States
(12) Patent Application Publication
(10) Pub. No.: US 2008/0203369 A1
(43) Pub. Date: Aug. 28, 2008

(54) SELF-TAILING WINCH

(76) Inventor: Hans P. Asmussen, Milwaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/029,804

(22) Filed: Feb. 12, 2008

Related U.S. Application Data
(60) Provisional application No. 60/903,133, filed on Feb. 23, 2007.

(51) Int. Cl. B66D 1/34

(52) U.S. Cl. 254/371

(57) ABSTRACT

A winch, a retainer assembly and a method for assembling a winch. The winch may include a fixed first housing supportable on a surface, and a second housing supported for pivoting movement relative to the first housing, the second housing including a winding portion and spaced apart flanges defining an outwardly-facing groove, a line being windable on the winding portion and positionable in the groove, the winch being operable to apply a pulling force to the line. A retainer assembly may include a support connected to the first housing, and a retainer connected to the support and positioned to cover at least a portion of the winch groove, the retainer inhibiting radial movement of the line from the groove. In some constructions, the support has a flexible portion allowing movement of the retainer relative to the first housing. In some construction, the retainer includes a first retainer member and a second retainer member supported by the support to define a space between the first retainer member and the second retainer member, the line being radially movable relative to the groove through the space.

### RELATED APPLICATIONS

This application claims the benefit of provisional U.S. Patent Application Ser. No. 60/903,133, filed Feb. 23, 2007, the entire disclosure of which is incorporated herein by reference.

### FIELD OF THE INVENTION

The present invention relates to winches and, more particularly, to self-tailing winches which may be used on sailboats.

### BACKGROUND

A winch is a mechanical device that is used to wind up rope or cable. Winches can include a spool or winch drum and an attached crank. The rope is usually stored on the winch. When trimming a rope or line on a sailboat, the winch handle is turned with one hand while the loose end of the rope is tailed or pulled on to maintain tension. Some winches have a V-shaped slot, formed between by a pair of flanges, to maintain tension on the loose end of the rope and are known as self-tailing winches. One example of such a winch is disclosed in U.S. Pat. No. 4,475,718, the entire contents of which is incorporated herein by reference.

### SUMMARY

In one independent embodiment, the invention provides a retainer assembly for a self-tailing winch, the winch including a fixed first housing connectable to a surface and a second housing supported for pivoting movement by the first housing, the second housing including a winding portion and defining an outwardly-facing groove, a line being windable on the winding portion and supportable in the groove, the winch being operable to apply a pulling force to the line. The retainer assembly may include a support connected to the first housing, and a retainer connected to the support and positioned to cover at least a portion of the winch groove, the retainer inhibiting radial movement of the line from the groove.

In some constructions, the support may have a flexible portion allowing movement of the retainer relative to the first housing. The retainer may include an upper fairlead or first retainer member and a lower fairlead or second retainer member supported by the support to define a space between the first retainer member and the second retainer member, the line being radially movable relative to the groove through the space. The support includes a first support member supporting the first retainer member on the first housing, and a second support member supporting the second retainer member on the first housing. A stripper member may close a circumferential end of the groove, the stripper member causing the line to exit the groove.

In another independent embodiment, the invention provides a winch assembly generally including a winch and a retainer assembly. The winch may includes a fixed first housing supportable on a surface, and a second housing supported for pivoting movement relative to the first housing, the second housing including a winding portion and spaced apart flanges defining an outwardly-facing groove, a line being windable on the winding portion and positionable in the groove, the winch being operable to apply a pulling force to the line. The retainer assembly may include a support connected to the first housing, and a retainer connected to the support and positioned to cover at least a portion of the winch groove, the retainer inhibiting radial movement of the line from the groove.

In a further independent embodiment, the invention provides a method for assembling a winch assembly, the winch assembly including a fixed first housing supportable on a surface, and a movable second housing supported for pivoting movement relative to the first housing, the second housing including a winding portion and spaced apart flanges defining an outwardly-facing groove, a line being windable on the winding portion and positionable in the groove. The method may include the acts of providing a retainer assembly including a support, and a retainer connected to the support, and connecting the support to the first housing to position the retainer to cover at least a portion of the groove, the retainer inhibiting radial movement of the line from the groove.

Independent aspects of the invention will become apparent by consideration of the detailed description, claims and accompanying drawings.

### BRIEF DESCRIPTION OF THE DRAWINGS

FIG. 1 is a front view of a self-tailing winch including a retainer assembly.

FIG. 2 is a top view of the winch shown in FIG. 1.

FIG. 3 is a side view of the winch shown in FIG. 1 with internal components shown in phantom.

FIG. 4 is a rotated front view of the winch shown in FIG. 1.

FIG. 5 is a front view of the winch shown in FIG. 1 and illustrating use of the winch with a line.

FIG. 6 is a top view of the winch and line shown in FIG. 5, with a portion of the line shown in phantom.

FIG. 7 is a side view of the winch and line shown in FIG. 5, with portions of the line in cross-section and in phantom, and illustrating use of the winch with a crank.

FIG. 8 is a side view of the winch and line shown in FIG. 5.

FIG. 9 is a rotated front view of the winch and line shown in FIG. 5.

FIG. 10 is a side view of the winch and line shown in FIG. 5 and illustrating movement of the line through the retainer mechanism.

FIG. 11 is a perspective view of a retainer mechanism for use with the winch, as shown in FIGS. 1-10.

FIG. 12 is an exploded perspective view of the retainer mechanism shown in FIG. 1 1.

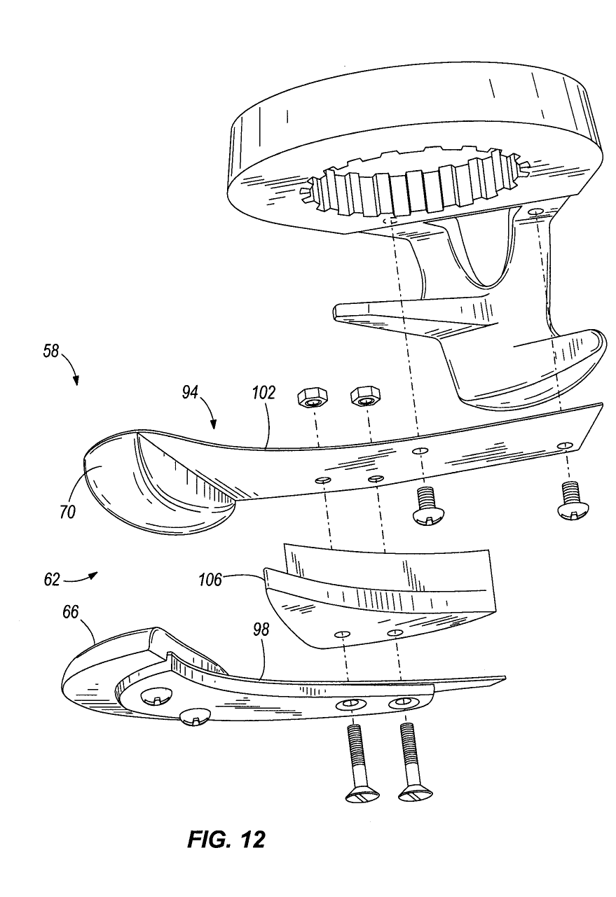

Before any independent embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

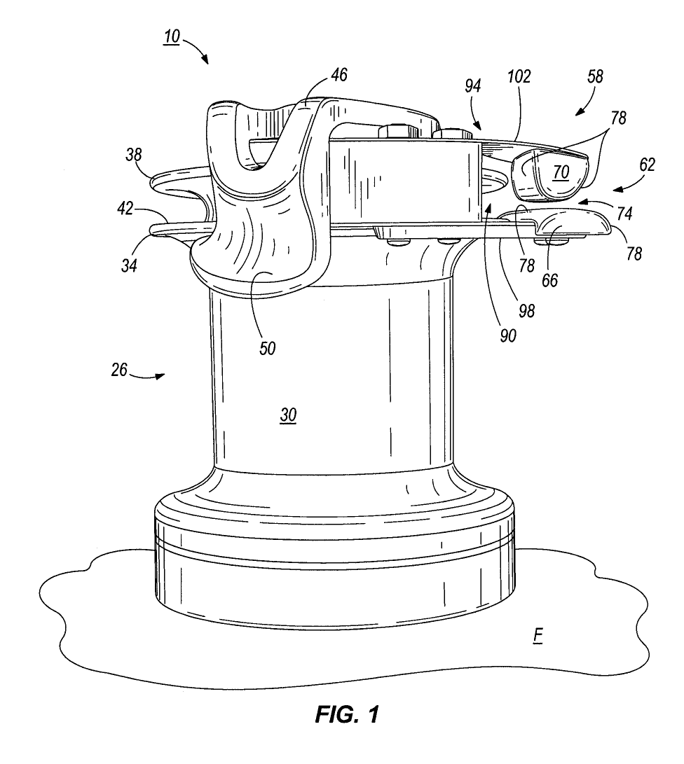

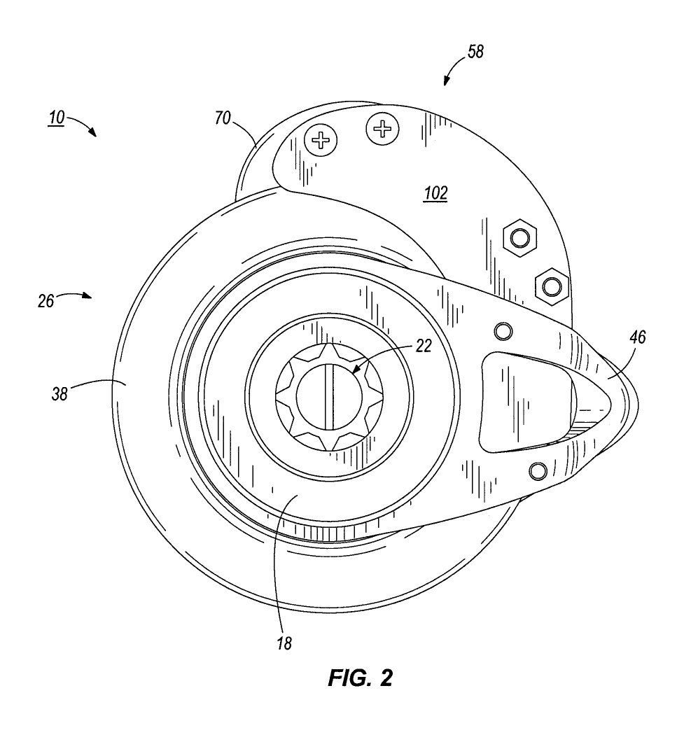

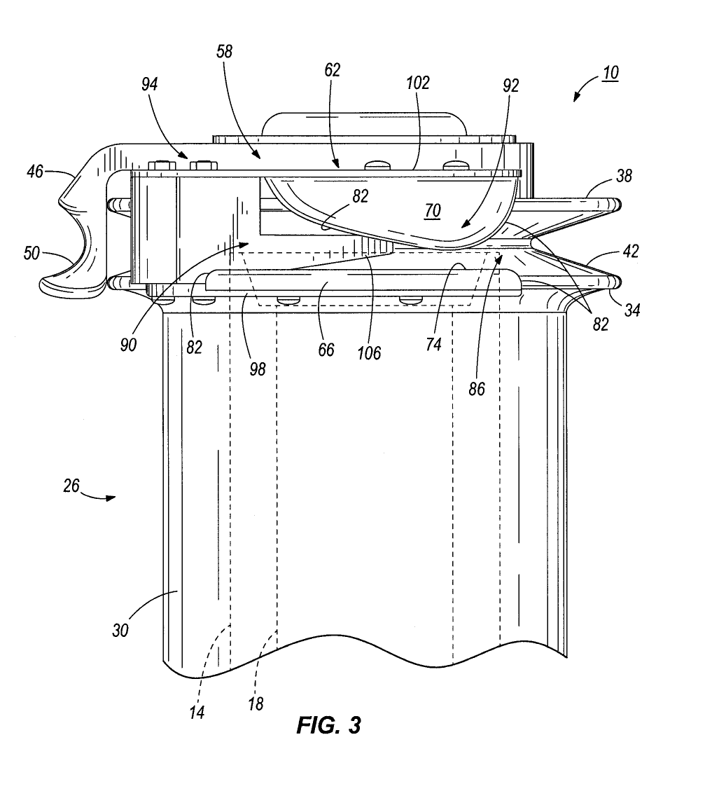

A self-tailing winch 10 is illustrated in the figures. The winch 10 may be similar to that disclosed in U.S. Pat. No. 4,475,718, and, as shown in FIG. 3, the winch 10 generally includes an inner fixed cylinder housing 14, a rotating shaft 18 disposed within the fixed cylinder 14 and having (see FIG. 2) a toothed inner diameter 22, and an outer housing 26 driven for pivoting movement relative to the fixed cylinder 14 by the shaft 18. As shown in FIG. 1, the winch 10 is supported on a footing F which is a working surface on, for example, a boat.

The outer housing 26 includes a winding portion 30 adjacent the footing F and a pair of spaced apart annular flanges 34, 38 on the opposite side of the winding portion 30 from the footing F. The flanges 34, 38 decrease in thickness towards the circumference, forming a generally V-shaped circumferential groove 42 therebetween.

An existing fairlead or stripper arm 46 is attached to an opposite end of the fixed cylinder 14 from the footing F and includes a portion 50 that extends across the flanges 34, 38 towards the footing F. The stripper arm 46 guides a line L (e.g., rope, cord, cable, etc.) wound about the winding portion 30 of the housing 22 into the groove 42.

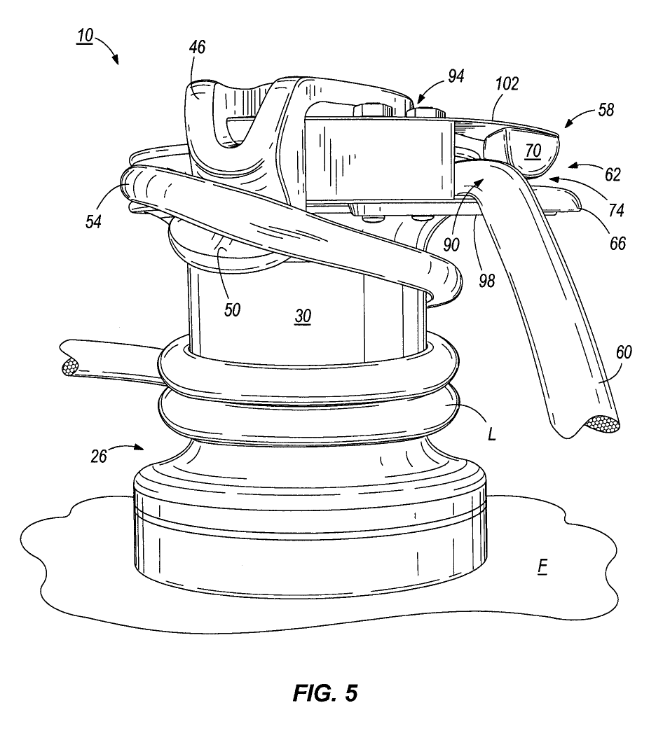

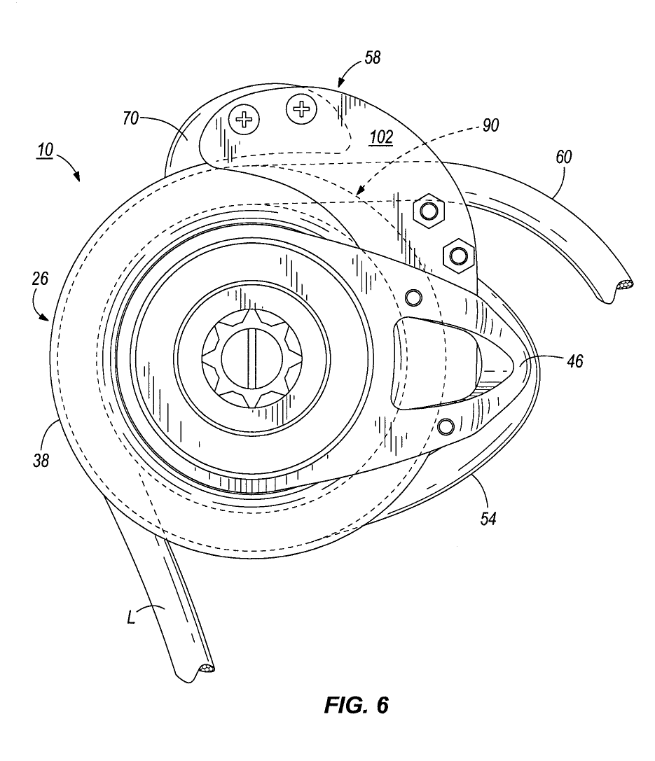

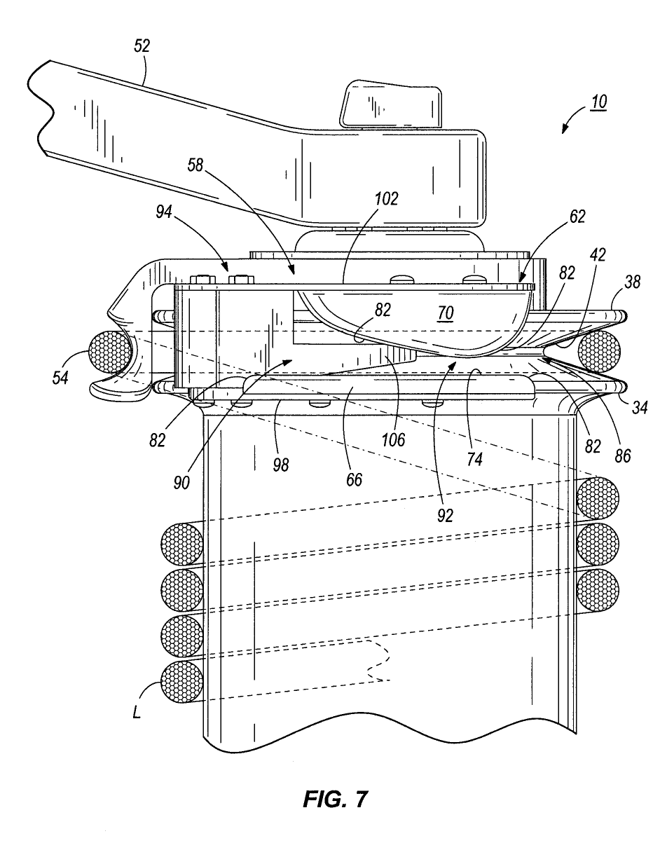

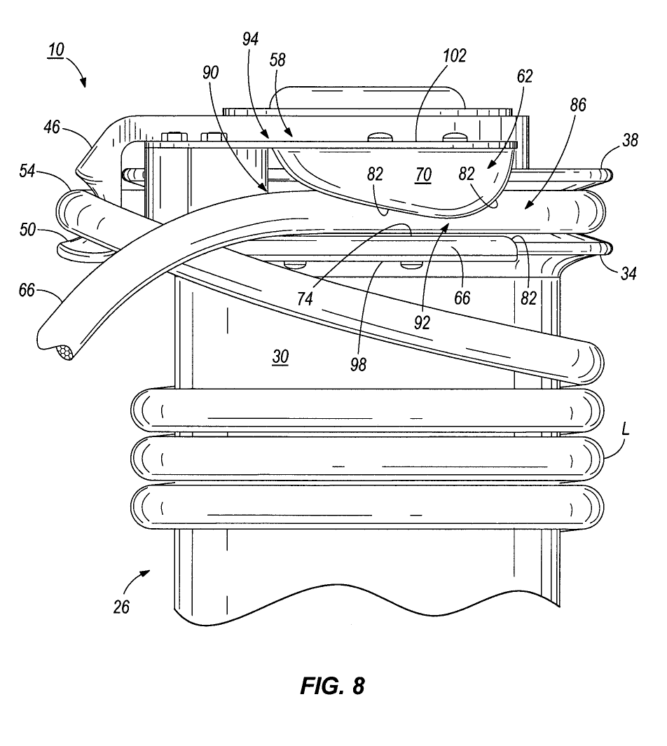

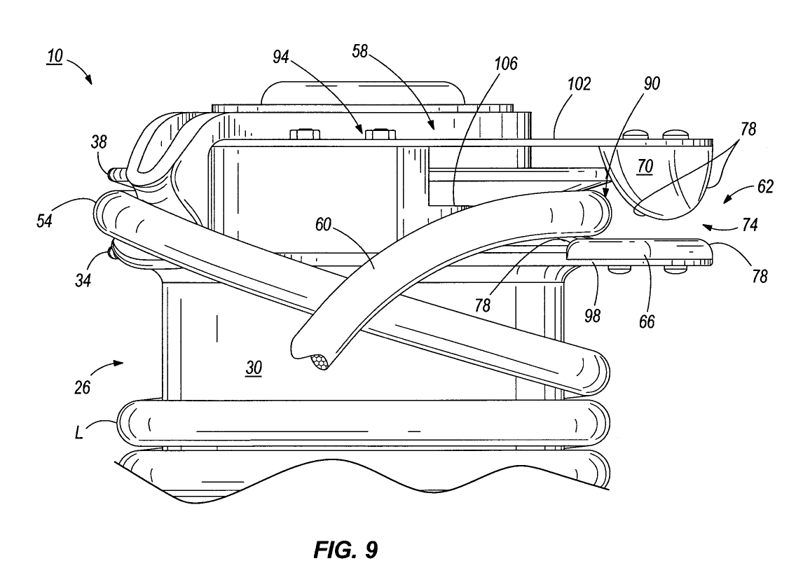

The toothed inner diameter 22 (FIG. 2) of the rotating shaft 18 is adapted to receive a crank 52 (see FIG. 7) having a toothed outer diameter (not shown) complementary to and engageable with the toothed inner diameter 22. The crank 52 can be used to impart rotational movement to the shaft 18 and, thus, to the housing 26, thereby winding the line L about the winding portion 30 of the housing 26. As shown in FIGS. 5-10, a portion 54 of the line L can be guided into the entrance of the groove 42 with the stripper arm 46.

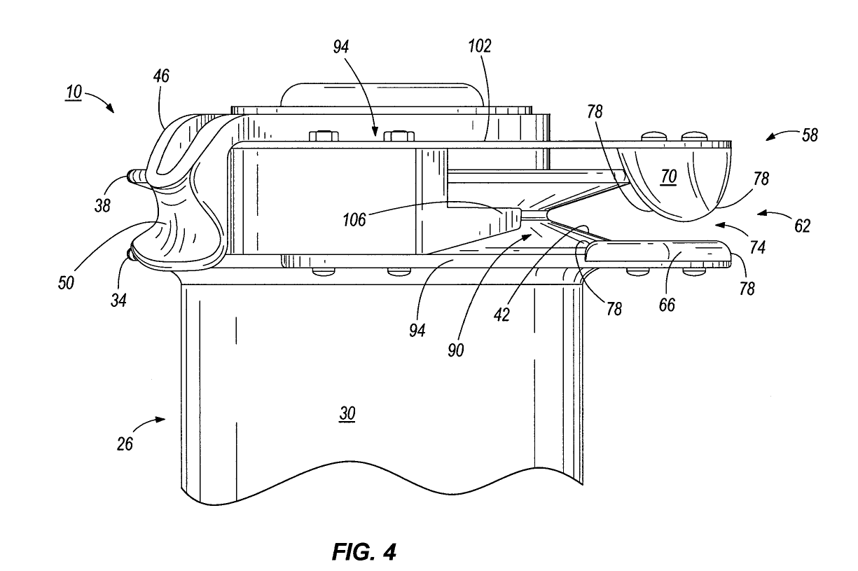

A retainer assembly 58 is used with the winch 10 and is operable to generally limit radial movement of the line L from the groove 42 to thereby maintain control of the tail end 60 of the line L. As shown in FIGS. 3-4, the retainer assembly 58 includes a retainer 62 which is located adjacent to and generally extends along a circumferential portion of the groove 42. The retainer 62 extends axially across at least a portion of the groove 42 to inhibit radial movement of the line L from the groove 42.

In the illustrated construction, the retainer 62 includes a pair of opposing fairleads or retainer members 66, 70 positioned to define a radial space 74 therebetween, and the space 74 is radially aligned with a portion of the groove 42. Surfaces 78, 82 on the radial sides and on the circumferential ends, respectively, of the retainer members 66, 70 are angled relative to a radial plane to lead into and out of the space 74. The retainer members 66, 70 form, circumferentially, a line inlet 86 and a line outlet 90 separated by a retaining region 92. In the illustrated construction, the retainer members 66, 70 are formed of a relatively low friction material, such as low friction plastic, such that circumferential movement of the line L is not impeded.

The retainer assembly 58 also includes a support 94 to support the retainer 62 relative to the groove 42. The support 94 includes support members 98, 102 for supporting the retainer members 66, 70, respectively, on the fixed cylinder 14. In the illustrated construction, the upper support member 102 is formed of a flexible material, such as spring steel, so that the upper retainer member 70 is movable relative to the lower retainer member 66 to increase and decrease the axial width of the space 74. In the illustrated construction, the lower support member 98 is formed of a rigid material, such as rigid steel, so that the lower retainer member 66 is generally stationary relative to the groove 42.

A stripper member 106 (FIGS. 3-4) is positioned circumferentially beyond the line inlet 86 of the retainer 58. The stripper member 106 is positioned at least partially in the groove 42 to “close” the circumferential end of the groove 42. The stripper member 106 forces the line L to exit the groove 42, thereby preventing the line L wrapping under the stripper arm 46.

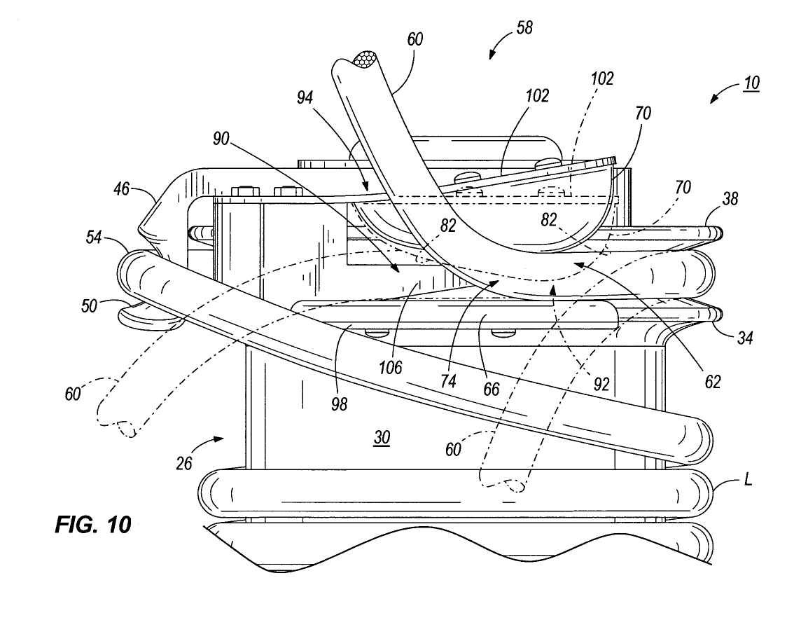

Use of the winch 10 and the retainer assembly 58 is illustrated in FIGS. 5-10. The line L is wound around the winding portion 30, over the stripper arm 46 and into the circumferential entrance of the groove 42. As illustrated in FIG. 10, the line L is pulled through the space 74 between the retainer members 66, 70 and into the portion of the groove 42 covered by the retainer 62. The line L exits the groove 42 through the outlet 90 at the stripper member 106. The crank 52 may be used to operate the winch 10 to apply a pulling force on the line L.

To relieve tension on the line L (e.g., to ease the sail), the line L is removed from the groove 42. The line L is pulled radially out of the groove 42, through the space 74 and past the retainer members 66, 70. Once the tension is set, the line L can be wrapped in the groove 42 and pulled radially inwardly through the retainer 62.

To accommodate radial movement of the line L past the retainer 62 (both inwardly and outwardly), in the illustrated construction, the upper retainer member 70 moves upwardly away from the lower retainer member 66 as the upper support member 102 is flexed upwardly. After the line L has passed radially between the retainer members 66, 70, the biasing force of the upper support member 102 causes the upper retainer member 70 to move toward the lower retainer member 66 and to return to the retaining position.

The biasing force on the upper retainer member 70 is sufficient to prevent the line L from sliding through space 74 or becoming disengaged from the retainer 62, generally absent a force applied by a user (e.g., a radial pulling force). Such a radial pulling force may be applied by hand by the user (pulling the line L into or out of the retainer 62). In the illustrated construction, if the line L is radially outward of the retainer 62, cranking the winch 10 will cause tail end 60 of the line L to be pulled radially inwardly through the retainer 62.

The retainer assembly 58 thereby serves to secure the tail end 60 of the line L against movement relative to the winch 10. In order to permit movement of the line L, the loose or tail end 60 is jerked or snapped toward the inlet 86 with sufficient force to deflect the first retainer member 70 away from the second retainer member 66, thereby releasing the line L.

The retainer assembly 58 provides a structure for securing the tail end 60 of the line L quickly and easily. Rather than having to wind additional portions of the line L about the winch 10 or to otherwise tie off the line L to prevent movement, the line L is secured with a single jerking motion adjacent to the V-shaped groove 42. The retainer assembly 58 will operate to retain the line L in the groove 42 regardless of the orientation in which the winch 10 is supported (e.g., upright, upside down, horizontally, etc.)

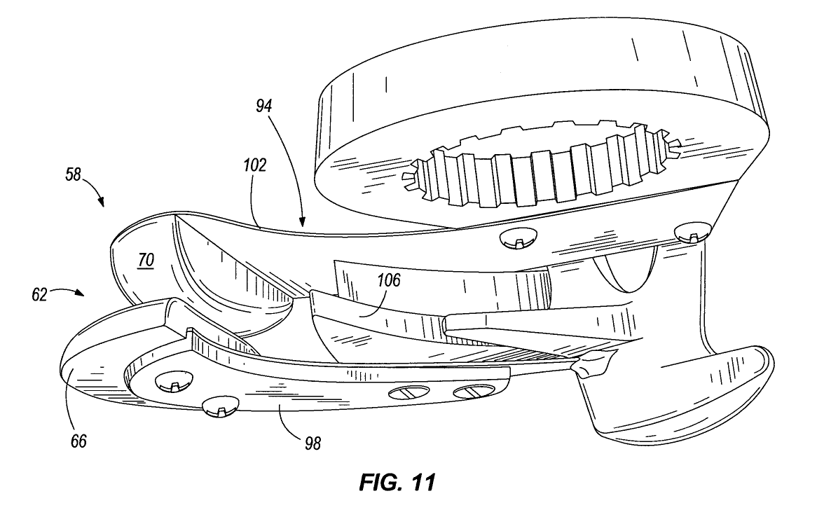

As shown in FIGS. 10-11, in the illustrated construction, the retainer 62, the support 94 and the stripper member 106 are connected as a unitary retainer assembly 58 to be supported on the fixed cylinder 14 with the stripper arm 46. The retainer assembly 58 may be connected to and used with an existing self-tailing winch, such as the winch 10, to modify the winch. In other constructions (not shown), the retainer assembly 58 may be formed as a part of the winch or of one or more components of the winch.

It should be understood that, in other constructions (not shown), the structure of the retainer assembly 58 may be different. For example, only a single retainer member, such as the retainer member 70 (in the illustrated position or in a reversed upwardly-facing lower position), may be used to inhibit movement of the line L from the groove 42. In such constructions, the single retainer member would radially cover at least a portion of the groove 42, and the line L would be movable past the retainer member into and out of the groove 42. Such movement of the line L may include radial and/or axial movement relative to the retainer member.

Also, in other constructions (not shown), the retainer assembly 58 may have different dimensions, such as, for example, a greater or lesser extent about the circumference of the outer housing and of the groove 42. In addition, in other constructions (not shown), the retainer members 66, 70 and the support members 98, 102, respectively, may be combined as unitary upper and lower members.

While in the illustrated construction, the upper retainer member 70 is movable relative to the groove 42, it should be understood that, in other construction (not shown), the lower retainer member 66 or both the retainer members 66, 70 may be movable relative to the groove 42 to increase and decrease the axial width of the space 74. In such constructions, the lower support member 98 or both support members 98, 102 may be formed of a flexible material, such as spring steel. In still other constructions (not shown), the retainer member(s) 66, 70 may be formed at least partially of a flexible material to provide such movement.

It should also be understood that, in other constructions (not shown), the retainer member(s) 66, 70 may be movable relative to the fixed cylinder 14 in another direction (e.g., radially, combination axially and radially) to allow movement of the line from the groove 42.

One or more independent features and independent advantages of the invention are set forth in the following claims:

What is claimed is:

1. A retainer assembly for a self-tailing winch, the winch including a fixed first housing connectable to a surface and a second housing supported for pivoting movement by the first housing, the second housing including a winding portion and defining an outwardly-facing groove, a line being windable on the winding portion and supportable in the groove, the winch being operable to apply a pulling force to the line, the retainer assembly comprising:
a support connected to the first housing; and
a retainer connected to the support and positioned to cover at least a portion of the winch groove, the retainer inhibiting radial movement of the line from the groove.

2. The retainer assembly as set forth in claim 1, wherein retainer is movable relative to the first housing to allow radial movement of the line relative to the groove.

3. The retainer assembly as set forth in claim 2, wherein the support has a flexible portion allowing movement of the retainer relative to the first housing.

4. The retainer assembly as set forth in claim 1, wherein the retainer includes a first retainer member and a second retainer member supported by the support to define a space between the first retainer member and the second retainer member, the line being radially movable relative to the groove through the space.

5. The retainer assembly as set forth in claim 4, wherein the support includes a first support member supporting the first retainer member on the first housing, and a second support member supporting the second retainer member on the first housing.

6. The retainer assembly as set forth in claim 5, wherein at least one of the first retainer member and the second retainer member is movable relative to the first housing to allow radial movement of the line relative to the groove and through the space.

7. The retainer assembly as set forth in claim 6, wherein at least one of the first support member and the second support member has a flexible portion allowing movement of the one of the first retainer member and the second retainer member relative to the first housing.

8. The retainer assembly as set forth in claim 1, wherein the retainer is at least partially formed of a low friction material.

9. The retainer assembly as set forth in claim 1, wherein the second housing has a circumference, and wherein the retainer extends about a portion of the circumference.

10. The retainer assembly as set forth in claim 1, further comprising a stripper member closing a circumferential end of the groove, the stripper member causing the line to exit the groove.

11. The retainer assembly as set forth in claim 10, wherein the stripper member, the support and the retainer are connected as a unit to the first housing.

12. A winch assembly comprising:
a winch including
a fixed first housing supportable on a surface, and
a second housing supported for pivoting movement relative to the first housing, the second housing including a winding portion and spaced apart flanges defining an outwardly-facing groove, a line being windable on the winding portion and positionable in the groove, the winch being operable to apply a pulling force to the line; and
a retainer assembly including
a support connected to the first housing, and
a retainer connected to the support and positioned to cover at least a portion of the winch groove, the retainer inhibiting radial movement of the line from the groove.

13. The winch assembly as set forth in claim 12, wherein retainer is movable relative to the first housing to allow radial movement of the line relative to the groove.

14. The winch assembly as set forth in claim 13, wherein the support has a flexible portion allowing movement of the retainer relative to the first housing.

15. The winch assembly as set forth in claim 12, wherein the retainer includes a first retainer member and a second retainer member supported by the support to define a space between the first retainer member and the second retainer member, the line being radially movable relative to the groove through the space.

16. The winch assembly as set forth in claim 15, wherein the support includes a first support member supporting the first retainer member on the first housing, and a second support member supporting the second retainer member on the first housing.

17. The winch assembly as set forth in claim 16, wherein at least one of the first retainer member and the second retainer member is movable relative to the first housing to allow radial movement of the line relative to the groove and through the space.

18. The winch assembly as set forth in claim 17, wherein at least one of the first support member and the second support member has a flexible portion allowing movement of the one of the first retainer member and the second retainer member relative to the first housing.

19. The winch assembly as set forth in claim 12, wherein the retainer is at least partially formed of a low friction material.

20. The winch assembly as set forth in claim 12, wherein the second housing has a circumference, and wherein the retainer extends about a portion of the circumference.

21. The winch assembly as set forth in claim 12, further comprising a stripper closing a circumferential end of the groove, the stripper causing the line to exit the groove.

22. The winch assembly as set forth in claim 21, wherein the stripper member, the support and the retainer are connected as a unit to the first housing.

23. A method for assembling a winch assembly, the winch assembly including a fixed first housing supportable on a surface, and a movable second housing supported for pivoting movement relative to the first housing, the second housing including a winding portion and spaced apart flanges defining an outwardly-facing groove, a line being windable on the winding portion and positionable in the groove, the method comprising the acts of:
providing a retainer assembly including a support, and a retainer connected to the support; and
connecting the support to the first housing to position the retainer to cover at least a portion of the groove, the retainer inhibiting radial movement of the line from the groove.
